(19) United States
(12) Patent Application Publication
(10) Pub. No.: US 2024/0195569 A1
(43) Pub. Date: Jun. 13, 2024

(54) METHOD AND DEVICE USED IN COMMUNICATION NODE FOR WIRELESS COMMUNICATION

(71) Applicant: Xiaobo ZHANG, Shanghai (CN)

(72) Inventor: Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/531,704

(22) Filed: Dec. 7, 2023

(30) Foreign Application Priority Data
Dec. 8, 2022 (CN) 202211568815.0

(51) Int. Cl. H04L 5/00; H04B 17/318; H04W 72/231; H04W 72/54

(52) U.S. Cl. CPC H04L 5/0051; H04B 17/328; H04W 72/231; H04W 72/54

(57) ABSTRACT

The present application provides a method and a device in a communication node for wireless communications. A communication node receives first information, second information and a first signaling, herein, only a former of the first information and the second information belongs to legacy SIB1; transmits a first message on a first radio resource, the first message comprises a random access preamble, the first radio resource belongs to a first resource set or the first radio resource belongs to a second resource set; herein, the first resource set depends on an indication of the legacy SIB1, and the first signaling is used to determine the second resource set. The scheme in the present application can reduce the random access delay of a legacy UE.

### CROSS REFERENCE TO RELATED APPLICATIONS

This application claims the priority benefit of Chinese Patent Application No. 202211568815.0, filed on Dec. 8, 2022, the full disclosure of which is incorporated herein by reference.

### BACKGROUND

### Technical Field

The present application relates to transmission methods and devices in wireless communication systems, and in particular to a transmission method and device related to random access.

### Related Art

In cellular communications, a base station typically utilizes broadcast information or system information to configure radio resources for Random Access (RA). In New Radio (NR) standard, RA resources are often associated with RS resources such as SS/PBCH block (SSB) or Channel State Information Reference Signal (CSI-RS) to achieve beam alignment.

In Release (R) 18 of 3rd Generation Partnership Project (3GPP), how the base station save energy becomes a research topic. To save energy, an intuitive way is to reduce the transmission of broadcast information or system information.

### SUMMARY

Inventors have found through researches that reducing the allocation of cell-common RA resources can save energy consumption of the base station; however, an issue that needs to be considered is that excessively sparse RA resources may increase the access latency of a legacy User Equipment (UE). To address the above problem, the present application provides a solution. Although the original intention of the above issue is for energy-saving topic, the present application is also applicable to non-energy saving scenarios, where similar technical effects can be achieved. Additionally, the adoption of a unified solution for various scenarios contributes to the reduction of hardware complexity and costs.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS38 series.

In one embodiment, interpretations of the terminology in the present application refer to definitions given in the 3GPP TS36 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a first node for wireless communications, comprising:
a first receiver, receiving first information and second information, only a former of the first information and second information belonging to legacy System Information Block1 (SIB1): receiving a first signaling: and
a first transmitter, transmitting a first message on a first radio resource, the first message comprising a random access preamble, the first radio resource belonging to a first resource set or the first radio resource belonging to a second resource set:
herein, the first resource set depends on an indication of the legacy SIB1, and the first signaling is used to determine the second resource set: for any radio resource in the first resource set, whether a candidate for the first radio resource comprises the radio resource depends on at least one of the following:
   whether reception quality of RS resources associated with the radio resource is greater than or not lower than a first threshold, and the first threshold depends on a configuration of the first information:
   whether a candidate for the first radio resource comprises radio resources of the second resource set:
for any radio resource in the second resource set, whether a candidate for the first radio resource comprises the radio resources depends on whether reception quality of RS resources associated with the radio resource is greater than or not lower than a second threshold, and the second threshold depends on a configuration of the second information.

In one embodiment, the above method balances payloads in a first resource set and a second resource set by setting an appropriate threshold.

In one embodiment, the above method reduces a payload of the first resource set by setting an appropriate threshold.

In one embodiment, the above method enables the first node to occupy RA resources other than the first resource set indicated by legacy SIB1, thus reducing congestion in the first resource set.

Specifically, according to one aspect of the present application, the first node for wireless communications is characterized in comprising:
the first receiver, receiving a first RS resource group,
herein, the first resource set and any radio resource in the first resource set are associated with an RS resource of the first RS resource group.

Specifically, according to one aspect of the present application, characteristics of the first node for wireless communications are that only when the candidate for the first radio resource does not comprise radio resources of the second resource set, the candidate for the first radio resource comprises radio resources of the first resource set.

In one embodiment, the above aspects can preferentially occupy radio resources of the second resource set, thus reducing the congestion of the first resource set.

Specifically, according to one aspect of the present application, characteristics of the first node for wireless communications are that when reception quality of RS resources associated with at least one radio resource in the second resource set is greater than or not lower than the second threshold, the candidate for the first radio resource in the second resource set only comprises radio resources whose reception quality of associated RS resources is greater than or not lower than the second threshold, and the candidate for the first radio resource does not comprise any radio resource whose reception quality of associated RS resources in the first resource set is not lower than or greater than the first threshold.

In one embodiment, the above aspects can preferentially occupy radio resources of the second resource set, thus reducing the congestion of the first resource set.

In one embodiment, when reception quality of RS resources associated with at least one radio resource in the second resource set is greater than or not lower than the second threshold, the candidate for the first radio resource does not comprise any radio resource in the first resource set.

In one embodiment, the above embodiments avoid occupying the first resource set while ensuring the transmission quality of the first message, which maximizes the possibility of avoiding the influence of sparse RA resources on the legacy UE.

In one embodiment, when reception quality of RS resources associated with at least one radio resource in the second resource set is greater than or not lower than the second threshold, and the candidate for the first radio resource comprises radio resources whose reception quality of associated RS resources in the first resource set is greater than or not lower than the first threshold.

In one embodiment, the above method balances payloads in a first resource set and a second resource set by setting an appropriate threshold.

Specifically, according to one aspect of the present application, characteristics of the first node for wireless communications are that the second information is cell-common, or the second information is UE group-common and the first node is a UE in the UE group.

In one embodiment of the above aspect, the second information is carried by a cell-common signaling.

In one embodiment of the above aspect, the second information is carried by a specific signaling.

In one embodiment, the cell-common signaling is a Radio Resource Control (RRC) Information Element (IE) or field other than the legacy SIB1 in the SIB1, and the legacy SIB1 is SIB1 of NR as recorded in 3GPP Release 17.

In one embodiment, the cell-common signaling is an SIB other than SIB1.

In one embodiment, the specific signaling is an RRC signaling.

In one embodiment, the specific signaling belongs to ServingCellConfigCommon IE.

In one embodiment, the specific signaling belongs to UplinkConfigCommon IE.

In one embodiment, the specific signaling is BWP-UplinkCommon IE.

In one embodiment, the specific signaling is rach-ConfigCommon IE.

In one embodiment, any UE in the UE group can interpret the second information.

In one embodiment, the UE group does not comprise a legacy UE.

In one embodiment, the UE group does not comprise a UE that only supports 3GPP release 17 or earlier release.

Specifically, according to one aspect of the present application, the first node for wireless communications is characterized in comprising:
the first receiver, receiving third information, the third information and the first signaling being used together to determine the second resource set;
herein, the third information is anRRC signaling, and the first signaling is a Medium Access Control (MAC) Control Element (CE) or Downlink Control Information (DCI).

The above method can quickly or flexibly indicate the second resource set, while balancing RA latency and RA resource overhead.

Specifically, according to one aspect of the present application, characteristics of the first node for wireless communications are that the first information comprises rsrp-ThresholdSSB, and a name of the second information comprises at least one of rsrp or threshold.

Specifically, according to one aspect of the present application, characteristics of the first node for wireless communications are that the candidate for the first radio resource belongs to the first RA resource set, and a value of REAMBLE_TRANSMISSION_COUNTER of an RA process of the first message is used to determine that the first RA resource set comprises the first resource set.

In one embodiment, the above aspect balances a payload of the first resource set while avoiding excessive RA latency of the first node.

The present application provides a second node for wireless communications, comprising:
a second transmitter, transmitting first information and second information, only a former of the first information and second information belonging to legacy SIB1; transmitting a first signaling; and
a second receiver, receiving a first message on a first radio resource, the first message comprising a random access preamble, the first radio resource belonging to a first resource set or the first radio resource belonging to a second resource set;
herein, the first resource set depends on an indication of the legacy SIB1, and the first signaling is used to determine the second resource set; for any radio resource in the first resource set, whether a candidate for the first radio resource comprises the radio resource depends on at least one of the following:
   whether reception quality of RS resources associated with the radio resource is greater than or not lower than a first threshold, and the first threshold depends on a configuration of the first information;
   whether a candidate for the first radio resource comprises radio resources of the second resource set;
for any radio resource in the second resource set, whether a candidate for the first radio resource comprises the radio resources depends on whether reception quality of RS resources associated with the radio resource is greater than or not lower than a second threshold, and the second threshold depends on a configuration of the second information.

The present application provides a method in a first node for wireless communications, comprising:
receiving first information and second information, only a former of the first information and second information belonging to legacy SIB1; receiving a first signaling;
transmitting a first message on a first radio resource, the first message comprising a random access preamble, the first radio resource belonging to a first resource set or the first radio resource belonging to a second resource set;
herein, the first resource set depends on an indication of the legacy SIB1, and the first signaling is used to determine the second resource set; for any radio resource in the first resource set, whether a candidate for the first radio resource comprises the radio resource depends on at least one of the following:
   whether reception quality of RS resources associated with the radio resource is greater than or not lower than a first threshold, and the first threshold depends on a configuration of the first information;
   whether a candidate for the first radio resource comprises radio resources of the second resource set;
for any radio resource in the second resource set, whether a candidate for the first radio resource comprises the radio resources depends on whether reception quality of RS resources associated with the radio resource is greater than or not lower than a second threshold, and the second threshold depends on a configuration of the second information.

Specifically, according to one aspect of the present application, characteristics of the method in the first node for wireless communications is in comprising:
receiving a first RS resource group,
herein, the first resource set and any radio resource in the first resource set are associated with an RS resource of the first RS resource group.

Specifically, according to one aspect of the present application, characteristics of the method in the first node for wireless communications are that only when the candidate for the first radio resource does not comprise radio resources of the second resource set, the candidate for the first radio resource comprises radio resources of the first resource set.

Specifically, according to one aspect of the present application, characteristics of the method in the first node for wireless communications is that when reception quality of RS resources associated with at least one radio resource in the second resource set is greater than or not lower than the second threshold, the candidate for the first radio resource in the second resource set only comprises radio resources whose reception quality of associated RS resources is greater than or not lower than the second threshold, and the candidate for the first radio resource does not comprise any radio resource whose reception quality of associated RS resources in the first resource set is not lower than or greater than the first threshold.

Specifically, according to one aspect of the present application, characteristics of the method in the first node for wireless communications are that the second information is cell-common, or the second information is UE group-common and the first node is a UE in the UE group.

Specifically, according to one aspect of the present application, characteristics of the method in the first node for wireless communications is in comprising:
receiving third information, the third information and the first signaling being used together to determine the second resource set;
herein, the third information is an RRC signaling, and the first signaling is a Medium Access Control (MAC) Control Element (CE) or Downlink Control Information (DCI).

Specifically, according to one aspect of the present application, characteristics of the method in the first node for wireless communications are that the first information comprises rsrp-ThresholdSSB, and a name of the second information comprises at least one of rsrp or threshold.

Specifically, according to one aspect of the present application, characteristics of method in the first node for wireless communications is that the candidate for the first radio resource belongs to the first RA resource set, and a value of REAMBLE_TRANSMISSION_COUNTER of an RA process of the first message is used to determine that the first RA resource set comprises the first resource set.

The present application provides a method in a second node for wireless communications, comprising:
transmitting first information and second information, only a former of the first information and second information belonging to legacy SIB1; transmitting a first signaling;
receiving a first message on a first radio resource, the first message comprising a random access preamble, the first radio resource belonging to a first resource set or the first radio resource belonging to a second resource set;
herein, the first resource set depends on an indication of the legacy SIB1, and the first signaling is used to determine the second resource set; for any radio resource in the first resource set, whether a candidate for the first radio resource comprises the radio resource depends on at least one of the following:
   whether reception quality of RS resources associated with the radio resource is greater than or not lower than a first threshold, and the first threshold depends on a configuration of the first information;
   whether a candidate for the first radio resource comprises radio resources of the second resource set;
for any radio resource in the second resource set, whether a candidate for the first radio resource comprises the radio resources depends on whether reception quality of RS resources associated with the radio resource is greater than or not lower than a second threshold, and the second threshold depends on a configuration of the second information.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a transmission of a first message according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 is a transmission flowchart of a first message according to one embodiment of the present application;

FIG. 6 illustrates a schematic diagram of a first resource set and a second resource set in time domain according to one embodiment of the present application;

FIG. 7 illustrates a flowchart of a transmission of a first message according to one embodiment of the present application;

FIG. 8 illustrates a flowchart of a determination of a candidate for a first radio resource according to one embodiment of the present application;

FIG. 9 illustrates a schematic diagram of a determination of a first RA resource set according to one embodiment of the present application;

FIG. 10 illustrates a structure block diagram of a processor in a first node according to one embodiment of the present application;

FIG. 11 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of a transmission of a first message according to one embodiment of the present application, as shown in FIG. 1.

In embodiment 1, a first node 100 receives first information, second information and a first signaling in step 101, herein, only a former of the first information and the second information belongs to legacy SIB1; transmits a first message on a first radio resource in step S102, the first message comprises a random access preamble, the first radio resource belongs to a first resource set or the first radio resource belongs to a second resource set;
in embodiment 1, the first resource set depends on an indication of the legacy SIB1, and the first signaling is used to determine the second resource set; for any radio resource in the first resource set, whether a candidate for the first radio resource comprises the radio resource depends on at least one of the following:
   whether reception quality of Reference Signal (RS) resources associated with the radio resources is greater than or not lower than a first threshold, and the first threshold depends on a configuration of the first information;
   whether a candidate for the first radio resource comprises radio resources of the second resource set;
for any radio resource in the second resource set, whether a candidate for the first radio resource comprises the radio resources depends on whether reception quality of RS resources associated with the radio resource is greater than or not lower than a second threshold, and the second threshold depends on a configuration of the second information.

In one embodiment, the above two occurrences of “greater than or not lower than” are both considered higher than.

In one embodiment, the above two occurrences of “greater than or not lower than” are both considered not lower than.

In one embodiment, any radio resource in the first resource set and any radio resource in the second resource set are orthogonal (non-overlapping) in time domain.

In one embodiment, the first signaling comprises a Medium Access Control (MAC) Control Element (CE).

In one embodiment, the first signaling comprises Downlink Control Information (DCI).

In one embodiment, the first signaling comprises a Radio Resource Control (RRC) signaling.

In one subembodiment of the above embodiment, the first signaling and the first information belong to a same RRC IE.

In one subembodiment of the above embodiment, the first signaling and the first information are different fields within a same RRC IE.

In one subembodiment of the above embodiment, the first signaling and the first information belong to a same SIB.

In one subembodiment of the above embodiment, the first signaling and the first information are different fields or different IEs in a same SIB.

In one embodiment, random access type of the first message is 4-step RA.

In one embodiment, random access type of the first message is 2-step RA.

In one embodiment, the first message corresponds to a contention-based random access.

In one embodiment, the first node is in RRC idle state.

In one embodiment, all radio resources comprised in the candidate for the first radio resource are associated with a same SSB.

In one embodiment, all radio resources of the candidate for the first radio resource in the first resource set are associated with an SSB.

In one embodiment, all radio resources of the candidate for the first radio resource in the second resource set are associated with an SSB.

In one embodiment, all radio resources comprised in the candidate for the first radio resource are associated with a same SSB.

In one embodiment, the base station and UE have the same understanding on an association between radio resources and an SSB.

In one embodiment, transmit power of the first node on a radio resource depends on pathloss measured on RS resources (or SSB) associated with the radio resources.
an association between radio resources and an SSB can be configured based on signaling, or predefined, or using mixed signaling configuration and predefined schemes. One mixed scheme comprises: SSBs are sorted according to ssb-Index, and radio resources are sorted in order according to preamble index (within a PRACH occasion), a PRACH occasion on frequency-domain resources, and a PRACH occasion on time-domain resources, and each sorted Q SSBs is associated with a PRACH occasion; Q is configured by the base station.

Some possible association schemes are also described in 3GPP standard TS38.213.

The above SSB-based association scheme can also be applied to CSI-RS resources, and will not be further elaborated in the present application.

In one embodiment, an RS resource is an SSB.

In one embodiment, an RS resource is indicated by an ssb-Index.

In one embodiment, an RS resource is a CSI-RS resource.

In one embodiment, a radio resource comprises at least one of a preamble index or a PRACH occasion.

In one embodiment, a radio resource is preamble index.

In one embodiment, a radio resource is a Physical Random Access CHannel (PRACH) occasion.

In one subembodiment of any embodiment of the above two embodiments, the probability of any radio resource in the candidate for the first radio resource being selected as the first radio resource is the same.

In one embodiment, a radio resource comprises a preamble index and a Physical Random Access CHannel (PRACH) occasion.

In one subembodiment of the above embodiment, the probability of any preamble index in the candidate for the first radio resource being selected as a preamble index of the first radio resource is the same, and the probability of any PRACH occasion in the candidate for the first radio resource being selected as a PRACH occasion of the first radio resource is the same.

In one subembodiment of the above embodiment, the probability of any radio resource in the candidate for the first radio resource being selected as the first radio resource is the same.

In one embodiment, the first message is MsgA, and the radio resources comprise a Physical Uplink Shared Channel (PUSCH) occasion occupied by the first message.

In one embodiment, the first message is MsgA, and radio resources comprise a preamble index and a Demodulation Reference Signal (DMRS) of a PUSCH occupied by the first message.

In one embodiment, the legacy SIB1 is SIB1 of NR.

In one embodiment, the legacy SIB1 is SIB1 of NR as recorded in 3GPP Release 15.

In one embodiment, the legacy SIB1 is SIB1 of NR as recorded in 3GPP Release 16.

In one embodiment, the legacy SIB1 is SIB1 of NR as recorded in 3GPP Release 17.

In one embodiment, how to select the first radio resource from the candidate for the first radio resource is determined by the first node itself.

In one embodiment, any radio resource in the candidate for the first radio resource being selected as the first radio resource meets 3GPP standard.

In one embodiment, how to select the first radio resource from the candidate for the first radio resource is implementation-related or does not require standardization.

In one embodiment, the first node ensures that the probability of any radio resource in the candidate for the first radio resource being selected as the first radio resource is the same.

In one embodiment, the first resource set is not configured with any feature indication in a first feature indication set, the first feature indication set comprises a Reduced Capabilities (RedCap) indication, a Small Data Transmission (SDT) indication, a Network Slice AS Group (NSAG) indication, and an MSG3 repetition indication.

In one embodiment, the second resource set is not configured with any feature indication in the first feature indication set.

In one embodiment, the candidate for the first radio resource belongs to an RA resource set not configured with any feature indication in the first feature indication set.

In one embodiment, the first message transmitted on the first radio resource is a first transmission of Msg1 of an RA process instead of a retransmission.

In one embodiment, the first message transmitted on the first radio resource is a first transmission of MsgA of an RA process instead of a retransmission.

In one embodiment, the first message transmitted on the first radio resource is any of multiple Msg1 transmissions of an RA process.

In one embodiment, the first message transmitted on the first radio resource is any of multiple MsgA transmissions of an RA process.

In one embodiment, the first resource set and the second resource set belong to an association period in time domain.

In one embodiment, the first resource set and the second resource set belong to an association pattern period in time domain.

The above two embodiments maintain good compatibility with existing standards.

In one embodiment, a first node 100 receives third information in step 101, and the third information and the first signaling are used together to determine the second resource set; herein, the third information is an RRC signaling, and the first signaling is a MAC CE or DCI.

In one embodiment, the third information is broadcast.

The above embodiments can save the signaling overhead.

In one embodiment, the third information and the first information belong to a same SIB.

In one embodiment, the third information and the first information belong to a same RRC IE.

In one embodiment, the third information indicates a resource pool, and the first signaling is used to determine the second resource set from the resource pool.

In one embodiment, the third information indicates a resource pool, and the resource pool comprises multiple PRACH slots; the second resource set belongs to the resource pool, the second resource set occupies at least one of the multiple PRACH slots in time domain, and the first signaling is used to determine an earliest PRACH slot occupied by the second resource set.

In one embodiment, the first signaling is DCI, and an earliest PRACH slot occupied by the second resource set in time domain is an earliest PRACH slot satisfying the following conditions among the multiple PRACH slots: not earlier than or later than a Q1-th slot after slots occupied by the first signaling, and the Q1 is configurable or fixed.

In one embodiment, the first signaling indicates Q1.

In one embodiment, Q1 is configured by an RRC signaling.

In one embodiment, Q1 is not greater than 4.

### Embodiment 2

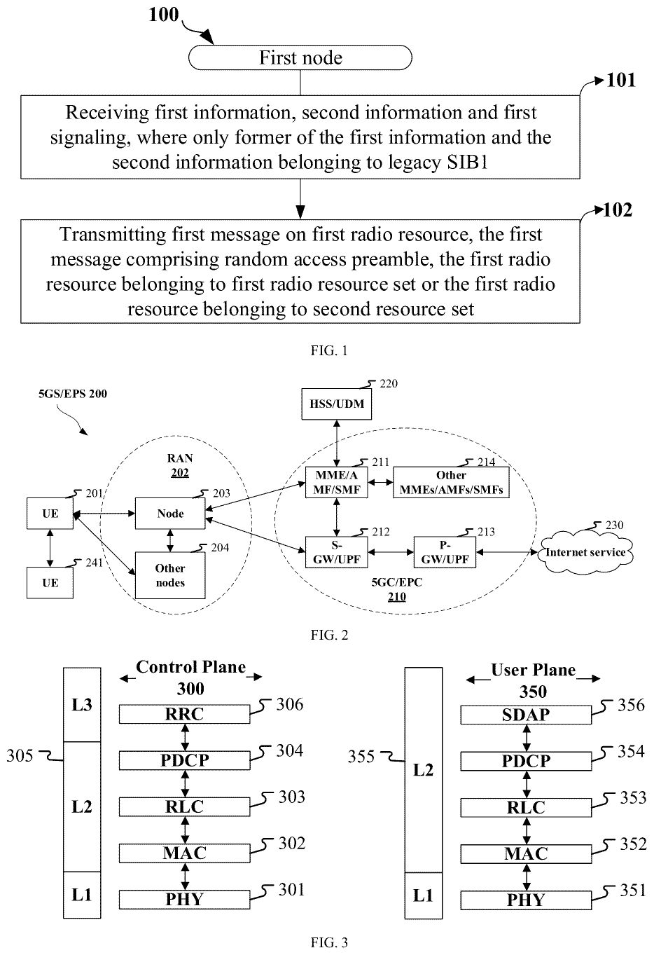

Embodiment 2 illustrates a schematic diagram of a network architecture according to one embodiment of the present application, as shown in FIG. 2. FIG. 2 is a diagram illustrating a network architecture 200 of 5G NR/Long-Term Evolution (LTE)/Long-Term Evolution Advanced (LTE-A) systems. The 5G NR/LTE/LTE-A network architecture 200 may be called a 5G System (5GS)/Evolved Packet System (EPS) 200 or other appropriate terms. The 5GS/EPS 200 comprises at least one of a UE 201, an RAN 202, a 5G Core Network/Evolved Packet Core (5GC/EPC) 210, a Home Subscriber Server (HSS)/Unified Data Management (UDM) 220 or an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The RAN comprises the node 203 and other nodes 204. The node 203 provides UE 201-oriented user plane and control plane protocol terminations. The node 203 may be connected to other nodes 204 via an Xn interface (e.g., backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application, and the node 203 corresponds to the second node in the present application.

In one embodiment, the UE 241 corresponds to the first node in the present application, and the node 203 corresponds to the second node in the present application.

In one embodiment, the UE 201 is a UE.

In one embodiment, the UE 201 is an ender.

In one embodiment, the node 201 corresponds to the first node in the present application.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB, or an eNB, or a ng-eNB, or an en-gNB.

In one embodiment, the node 203 is a relay.

In one embodiment, the node 203 is a gateway.

In one embodiment, the node 203 comprises at least one TRP.

In one embodiment, the node 204 is a BaseStation (BS).

In one embodiment, the node 204 is a BTS, a gNB, or an eNB, or a ng-eNB, or an en-gNB.

In one embodiment, the node 204 is a relay.

In one embodiment, the node 204 is a gateway.

In one embodiment, the node 204 comprises at least one TRP.

In one embodiment, the UE supports Terrestrial Network (NTN) transmission.

In one embodiment, the UE supports Non-Terrestrial Network (NTN) transmission.

In one embodiment, the UE supports communications within networks with large latency differences.

In one embodiment, the UE supports Dual Connection (DC) transmission.

In one embodiment, the UE comprises an aircraft.

In one embodiment, the UE comprises a vehicle terminal.

In one embodiment, the UE comprises a vessel.

In one embodiment, the UE comprises an Internet of Things (IoT) terminal.

In one embodiment, the UE comprises an Industrial Internet of Things (IIoT) terminal.

In one embodiment, the UE comprises a device supporting transmission with low-latency and high-reliability.

In one embodiment, the UE comprises test equipment.

In one embodiment, the UE comprises a signaling tester.

In one embodiment, the UE supports NR, UTRA, or EUTRA.

In one embodiment, the base station supports transmission over non-terrestrial networks.

In one embodiment, the base station supports transmission over networks with large latency differences.

In one embodiment, the base station supports transmission over terrestrial networks.

In one embodiment, the base station comprises a MarcoCellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station supporting large latency differences.

In one embodiment, the base station comprises flight platform equipment.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling tester.

In one embodiment, the base station comprises an Integrated Access and Backhaul (IAB)-node, or an IAB donor or an IAB-donor-CU, or an IAB-donor-DU.

In one embodiment, the base station comprises an IAB-DU.

In one embodiment, the base station comprises an IAB-MT.

In one embodiment, at least one of a connection between the UE 201 and the node 203 and a connection between the UE 201 and the node 204 exists.

In one subembodiment of the embodiment, a connection between the UE 201 and the node 203 exists, while a connection between the UE 201 and node 204 does not exist.

In one subembodiment of the embodiment, a connection between the UE 201 and the node 203 does not exist, while a connection between the UE 201 and node 204 exists.

In one subembodiment of the embodiment, a connection between the UE 201 and the node 203 exists, while a connection between the UE 201 and node 204 exists.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 is represented by three layers, which are a layer 1, a layer 2 and a layer 3, respectively. The layer 1 (L1) is the lowest layer and performs signal processing functions of various PHY layers. The L1 is called PHY 301 in the present application. L2 305, above the PHY 301, comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a data packet and provides support for handover. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating various radio resources (i.e., resources block) in a cell. The MAC sublayer 302 is also in charge of HARQ operation. The RRC sublayer 306 in L3 layer of the control plane 300 is responsible for acquiring radio resources (i.e., radio bearer) and configuring the lower layer with an RRC signaling. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Generally speaking, a layer above L1 is called a higher layer.

In one embodiment, the radio protocol architecture in FIG. 3 is applicable to the first node in the present application.

In one embodiment, the radio protocol architecture in FIG. 3 is applicable to the second node in the present application.

In one embodiment, the first information, the second information and the third information in the present application are generated by the RRC 306.

In one embodiment, the first signaling in the present application is generated by the MAC 352.

In one embodiment, the first signaling in the present application is generated by the PHY 301.

In one embodiment, the first message in the present application is generated by the PHY 301.

In one embodiment, a reception of RS resources in the present application is performed at the PHY301.

### Embodiment 4

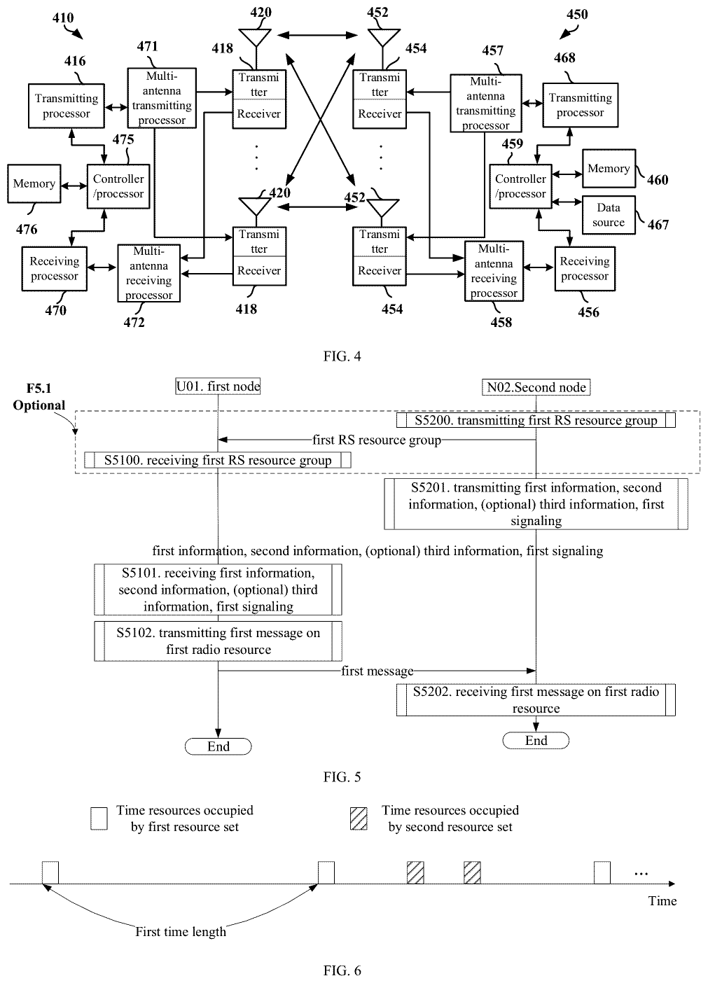

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory, at least one processor and at least one memory. The at least one memory comprises computer program codes; the at least one memory and the computer program codes are configured to be used in collaboration with the at least one processor, the first communication device 450 at least: receives first information and second information, only a former of the first information and second information belongs to Legacy SIB1; receives a first signaling; transmits a first message on a first radio resource, the first message comprises a random access preamble, the first radio resource belongs to a first resource set or the first radio resource belongs to a second resource set.

In one embodiment, the first communication device 450 comprises at least one processor and at least one memory, a memory that stores a computer readable instruction program. The computer readable instruction program generates an action when executed by at least one processor. The action includes: receiving first information and second information, only a former of the first information and second information belonging to legacy SIB1; receiving a first signaling; transmitting a first message on a first radio resource, the first message comprising a random access preamble, the first radio resource belonging to a first resource set or the first radio resource belonging to a second resource set.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits first information and second information, only a former of the first information and second information belongs to Legacy SIB1; transmits a first signaling; receives a first message on a first radio resource, the first message comprises a random access preamble, the first radio resource belongs to a first resource set or the first radio resource belongs to a second resource set.

In one embodiment, the second communication device 410 comprises a memory that stores a computer readable instruction program. The computer readable instruction program generates an action when executed by at least one processor. The action includes: transmitting first information and second information, only a former of the first information and second information belonging to legacy SIB1; transmitting a first signaling; receiving a first message on a first radio resource, the first message comprising a random access preamble, the first radio resource belonging to a first resource set or the first radio resource belonging to a second resource set.

In one embodiment, the antenna 452, the receiver 454, the receiving processor 456, and the controller/processor 459 are used to receive the first information and the second information; at least one of the antenna 420, the transmitter 418, the transmitting processor 416, or the controller/processor 475 is used to transmit the first information and the second information.

In one embodiment, the antenna 452, the receiver 454, the receiving processor 456, the controller/processor 459 are used to receive the first signaling; at least one of the antenna 420, the transmitter 418, the transmitting processor 416, or the controller/processor 475 is used to transmit the first signaling.

In one embodiment, the antenna 452, the receiver 454, the receiving processor 456, and the controller/processor 459 are used to receive a first RS resource group; at least one of the antenna 420, the transmitter 418, the transmitting processor 416, or the controller/processor 475 is used to transmit the first RS resource group.

In one embodiment, the antenna 452, the transmitter 454, the transmitting processor 468, and the controller/processor 459 are used to transmit the first message; at least one of the antenna 420, the receiver 418, the receiving processor 470, or the controller/processor 475 is used to receive the first message.

In one embodiment, the first communication device 450 corresponds to a first node in the present application.

In one embodiment, the second communication device 410 corresponds to a second node in the present application.

In one embodiment, the first communication device 450 is a UE, and the second communication device 410 is a base station.

In one embodiment, the UE supports large delay differences, or Non-Terrestrial Networks (NTNs), or capable of flying.

In one embodiment, the first communication device 410 has the energy-saving capability.

In one embodiment, the first communication device 450 is a UE that supports Terrestrial Networks (TNs).

In one embodiment, the second communication device 410 is a base station (gNB/eNB/ng-eNB).

### Embodiment 5

Embodiment 5 illustrates a flowchart of transmission of a first message according to one embodiment of the present application, as shown in FIG. 5, where steps in box F5.1 are optional. It is particularly underlined that the order illustrated in the embodiment does not put constraints over sequences of signal transmissions and implementations; for example, the transmission and reception of a first RS resource group may be periodic, and the transmission and reception of the first information may be multi-shot; for example, second information and first information may belong to a same RRC IE, or the first signaling may belong to a same RRC IE as the first information.

The first node U01 receives a first RS resource group in step S5100, herein, the first resource set and any radio resource in the first resource set are associated with an RS resource of the first RS resource group; in step S5101, receives first information, second information and a first signaling; in step S5102, transmits a first message on a first radio resource, the first message comprises a random access preamble, the first radio resource belongs to a first resource set or the first radio resource belongs to a second resource set;

The second node N02 transmits the first RS resource group in step S5200; in step S5201, transmit the first information, the second information and the first signaling; in step S5202, receives the first information in step S5202;
in embodiment 5, only a former of the first information and the second information belongs to legacy SIB1, the first resource set depends on an indication of the legacy SIB1, and the first signaling is used to determine the second resource set; for any radio resource in the first resource set, whether a candidate for the first radio resource comprises the radio resource depends on at least one of the following:
   whether reception quality of RS resources associated with the radio resource is greater than or not lower than a first threshold, and the first threshold depends on a configuration of the first information;
   whether a candidate for the first radio resource comprises radio resources of the second resource set;
for any radio resource in the second resource set, whether a candidate for the first radio resource comprises the radio resources depends on whether reception quality of RS resources associated with the radio resource is greater than or not lower than a second threshold, and the second threshold depends on a configuration of the second information.

In one embodiment, the reception quality is Reference Signal Receiving Power (RSRP).

In one embodiment, the reception quality is L1-RSRP.

In one embodiment, both the first threshold and the second threshold are measured by dBm.

In one embodiment, both the first threshold and the second threshold are measured by w.

In one embodiment, both the first threshold and the second threshold are measured by mw.

In one embodiment, the reception quality is Channel Quality Information (CQI), and the first threshold and the second threshold are respectively a CQI index.

In one embodiment, only when the candidate for the first radio resource does not comprise radio resources of the second resource set, the candidate for the first radio resource comprises radio resources of the first resource set.

In one subembodiment of the above embodiment, when reception quality of RS resources associated with at least one radio resource in the second resource set is greater than (or not lower than) the second threshold, the candidate for the first radio resource only comprises radio resources in the second resource set whose reception quality of associated RS resources is greater than (or not lower than) the second threshold.

In one subembodiment of the above embodiment, when there does not exist radio resource in the second resource set whose reception quality of associated RS resources greater than (or not lower than) the second threshold and there exists at least one radio resource in the first resource set whose reception quality of associated RS resources is greater than (or not lower than) the first threshold, and the candidate for the first radio resource only comprises radio resources in the first resource set whose reception quality of associated RS resources in the first resource set greater than (or not lower than) the first threshold.

In one subembodiment of the above embodiment, when there does not exist radio resources in the second resource set whose reception quality of associated RS resources is greater than (or not lower than) the second threshold and there does not exist radio resources in the first resource set whose reception quality of associated RS resources is greater than (or not lower than) the first threshold, the candidate for the first radio resource only comprises radio resources in the second resource set.

In one embodiment, when there exists at least one radio resource in the second resource set whose reception quality of associated RS resources is greater than (or not lower than) the second threshold, the candidate for the first radio resource in the second resource set only comprises radio resources whose reception quality of associated RS resources is greater than (or not lower than) the second threshold, and the candidate for the first radio resource does not comprise any radio resource in the first resource set whose reception quality of associated RS resources is not lower than (or higher than) of the first threshold.

In one subembodiment of the above embodiment, when reception quality of RS resources associated with at least one radio resource in the second resource set is greater than or not lower than the second threshold, the candidate for the first radio resource does not comprise any radio resource in the first resource set.

In one subembodiment of the above embodiment, when reception quality of RS resources associated with at least one radio resource in the second resource set is greater than (or not lower than) the second threshold, the candidate for the first radio resource comprises radio resources in the first resource set whose reception quality of associated RS resources is greater than (or not lower than) the first threshold.

In one embodiment, the second information is cell-common.

In one embodiment, the second information belongs to SIB1 and does not belong to the legacy SIB1, and the legacy SIB1 is SIB1 of NR as recorded in 3GPP Release 17.

In one embodiment, the second information belongs to SIB1 as recorded in 3GPP release 18 and does not belong to the legacy SIB1, and the legacy SIB1 is SIB1 of NR as recorded in 3GPP release 17.

In one embodiment, the second information is cell-common, and the second information is carried through an RRC-specific signaling.

In one subembodiment of the above embodiment, network device or base station ensures that the second information received by multiple UEs is the same.

In one embodiment, the second information is SIB other than SIB1.

In one embodiment, the second information is UE group-common and the first node is a UE in the UE group.

In one embodiment, the first information comprises rsrp-ThresholdSSB, and a name of the second information comprises at least one of rsrp or threshold.

In one embodiment, the second information comprises rsrp-ThresholdSSB.

In one embodiment, the second information comprises rsrp-ThresholdSSB-r18.

In one embodiment, the candidate for the first radio resource belongs to the first RA resource set, and a value of REAMBLE_TRANSMISSION_COUNTER of an RA process of the first message is used to determine that the first RA resource set comprises the first resource set.

In one embodiment, only when the value of PREAMBLE_TRANSMISSION_COUNTER of the RA process of the first message is greater than a first integer, the first RA resource set comprises the first resource set.

In one embodiment, the first integer is configurable.

In one embodiment, the first integer is fixed.

In one embodiment, the first integer is not less than 0 and not greater than preambleTransMax.

In one embodiment, the first integer is greater than 0 and not greater than preambleTransMax.

In one embodiment, the first node U01 receives third information in the step S5101, and the second node U02 transmits third information in the step S5201; herein, the third information is an RRC signaling, and the first signaling is a MAC CE or DCI.

In one subembodiment of the above embodiment, the first signaling is after the third information.

In one subembodiment of the above embodiment, the first signaling is after the first information, the second information and the third information.

### Embodiment 6

Embodiment 6 illustrates a schematic diagram of a first resource set and a second resource set in time domain, as shown in FIG. 6. In FIG. 6, the blank small squares and the slash-filled small squares respectively represent time resources occupied by a first resource set and time resources occupied by a second resource set.

In embodiment 6, the first resource set and the second resource set are orthogonal in time domain.

In one embodiment, each small square in FIG. 6 represents a subframe.

In one embodiment, each small square in FIG. 6 represents a slot.

In one embodiment, in FIG. 6, there are multiple PRACH slots in each small square, and any two of the multiple PRACH slots are orthogonal in time domain.

In one embodiment, each small square in FIG. 6 represents a PRACH slot.

In one embodiment, there are multiple time multiplexed PRACH occasions in each PRACH slot.

In one embodiment, there are multiple frequency multiplexed PRACH occasions in each PRACH slot.

In one embodiment, the first resource set consists of time-domain resources occupied by at least one PRACH occasion in time domain.

In one embodiment, the first resource set consists of time-domain resources occupied by at least one PRACH occasion in time domain.

In one embodiment, a time interval between any two adjacent blank squares in FIG. 6 is a first time length.

In one embodiment, the first time length comprises at least one ms.

In one embodiment, the first time length is a PRACH configuration period.

In one embodiment, a first signaling is used to activate the second resource set.

In one embodiment, there at least exists one SSB only being associated with radio resources in one of the first resource set and the second resource set.

### Embodiment 7

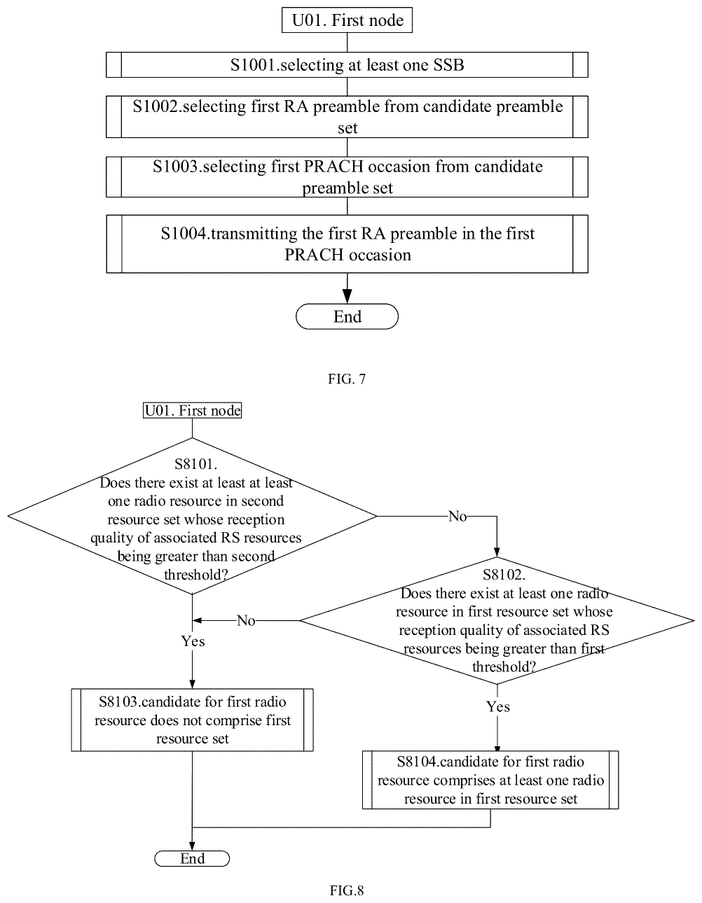

Embodiment 7 illustrates a schematic diagram of a transmission of a first message according to one embodiment of the present application, as shown in FIG. 7.

In embodiment 7, a first node U01 selects at least one SSB in step S1001; selects a first RA preamble from a candidate preamble set in step S1002, the candidate preamble set consists of at least one RA preamble, and any RA preamble in the candidate preamble set is associated with one SSB in the at least one SSB; selects a first PRACH occasion from a candidate occasion set in step S1003, the candidate occasion set consists of at least one PRACH, and any PRACH in the candidate occasion set corresponds to one or multiple SSBs in the at least one SSB; transmits the first RA preamble in the first PRACH occasion in step S1004.

In one embodiment, the step S1001, the step S1002, and the step S1003 are executed between step S5101 and the S5102 in embodiment 5; the step S1004 is the step S5102 (the first RA preamble is the first message, and the first radio resource comprises the first PRACH occasion and a preamble index of the first RA preamble), or a part of the step S5102 (for example, the first message also comprises a PUSCH).

In one embodiment, all PRACH occasions in the candidate occasion set belong to a same association period.

In one embodiment, the first node U01 randomly selects an RA preamble from the candidate preamble set with equal probability as the first RA preamble, and the first node U01 randomly selects a PRACH occasion from the candidate occasion set with equal probability as the first PRACH occasion.

In one embodiment, the at least one SSB only comprises an SSB.

In one embodiment, if a candidate for the first radio resource only comprises (part or all) radio resources in the second resource set, or the candidate for the first radio resource only comprises (part or all) radio resources in the first resource set, and at least one SSB only comprises one SSB.

In one subembodiment of the above embodiment, if there exists at least one SSB with reception quality greater than a second threshold in a candidate SSB set, the SSB is an SSB whose reception quality is greater than (or not lower than) a second threshold selected by the first node from a candidate SSB set; if there does not exist an SSB whose reception quality is greater than a second threshold, the SSB is any SSB selected by the first node from a candidate SSB set; the candidate SSB set consists of all SSBs associated with the second resource set, and a candidate for the first radio resource only comprises radio resources associated with the SSB in the second resource set.

In one subembodiment of the above embodiment, the SSB is an SSB whose reception quality is greater than (or not lower than) a first threshold selected by the first node from a candidate SSB set; the candidate SSB set consists of all SSBs associated with the first resource set; a candidate for the first radio resource only comprises radio resources associated with the SSB in the first resource set.

In one embodiment, if a candidate for the first radio resource comprises both (partial or all) radio resources in the second resource set and (partial or all) radio resources in the first resource set, the first node selects a first SSB from a first candidate SSB set and a second SSB from a second candidate SSB set; the at least one SSB comprises the first SSB and the second SSB; a candidate for the first radio resource comprises radio resources associated with the second SSB in the second resource set, as well as radio resources associated with the first SSB in the first resource set; the first candidate SSB set consists of all SSBs associated with the first resource set, and the second candidate SSB set consists of all SSBs associated with the second resource set.

In one embodiment, a selection of the first SSB and a selection of the second SSB are determined by the first node itself.

In one embodiment, if there exists at least one SSB with reception quality greater than a second threshold in the second candidate SSB set, the second SSB is an SSB whose reception quality is greater than (or not lower than) a second threshold selected by the first node from the second candidate SSB set; if there is no SSB with reception quality greater than a second threshold in the second candidate SSB set, the second SSB is any SSB selected by the first node from the second candidate SSB set.

In one embodiment, the first SSB is an SSB whose reception quality is greater than (or not lower than) a first threshold selected by the first node from the first candidate SSB set.

### Embodiment 8

Embodiment 8 illustrates a flowchart of a determination of a candidate for a first radio resource according to one embodiment of the present application, as shown in FIG. 8.

In embodiment 8, a first node judges in step S8101 whether there exists at least one radio resource in a second resource set whose reception quality of associated RS resources is greater than (or not lower than) a second threshold; if yes, in step S8103, determines that a candidate for the first radio resource does not comprise a first resource set; if no, judges in step S8102 whether there exists at least one radio resource in a first resource set whose reception quality of associated RS resources is greater than (or not lower than) a first threshold; if no, executes the step S8103, if yes, determines in step S8104 that a candidate for the first radio resource comprises at least one radio resource in the first resource set.

In one embodiment, the determination behavior in the step S8103 may be implicitly implemented, for example, the first node selects the at least one radio resource from radio resources in the second resource set whose reception quality of associated RS resources is greater than (or not lower than) a second threshold.

In one embodiment, the determination behavior in step S8104 may be implicitly implemented, for example, the first node selects the first radio resource from the at least one radio resource in the first resource set.

In one embodiment, the step S8104 comprises: determining that the candidate for the first radio resource does not comprise any radio resource in the second resource set.

In one embodiment, the step S8104 comprises: determining that the candidate for the first radio resource comprises at least one radio resource in the second resource set.

### Embodiment 9

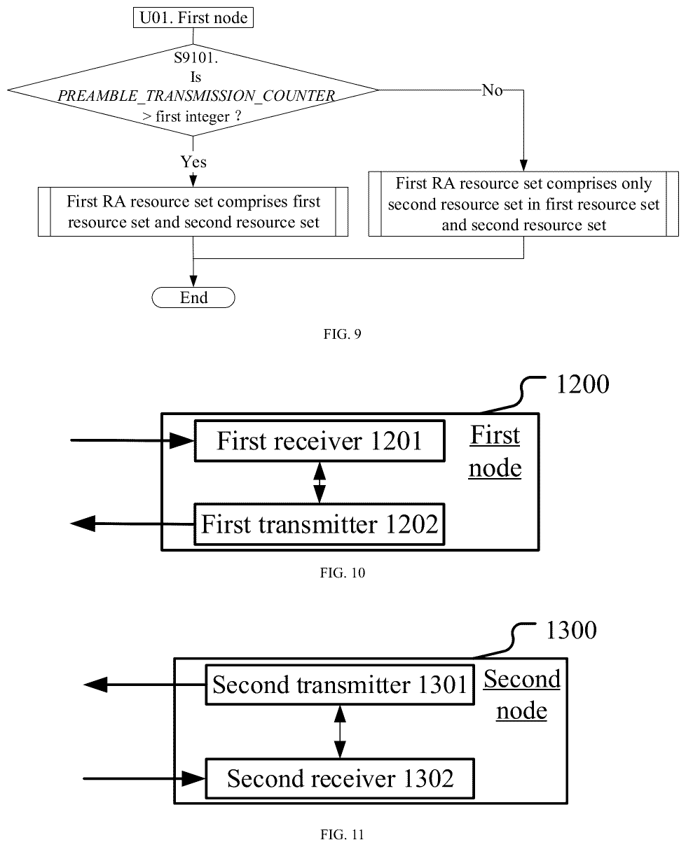

Embodiment 9 illustrates a flowchart of a determination of a first RA resource set according to one embodiment of the present application, as shown in FIG. 9.

The first node U01 judges in step S9101 whether PREAMBLE_TRANSMISSION_COUNTER is greater than (or not less than) a first integer; if yes, a first RA resource set comprises a first resource seta and a second resource set; if no, a first RA resource set comprises only a second resource set in a first resource set and a second resource set.

In embodiment 9, the candidate for the first radio resource belongs to a first RA resource set. Only when a first RA resource set comprises a first resource set and a second resource set, for any radio resource in the first resource set, whether a candidate for the first radio resource comprises the radio resource depends on at least one of the following:
whether reception quality of RS resources associated with the radio resource is greater than or not lower than a first threshold, and the first threshold depends on a configuration of the first information;
whether a candidate for the first radio resource comprises radio resources of the second resource set.

### Embodiment 10

Embodiment 10 illustrates a structure block diagram of a processor in a first node according to one embodiment of the present application, as shown in FIG. 10. In FIG. 10, a processor 1200 in a first node comprises a first receiver 1201 and a first transmitter 1202.

The first receiver 1201 receives first information, second information and a first signaling in step 101, herein, only a former of the first information and the second information belongs to legacy SIB1; the first transmitter 1202 transmits a first message on a first radio resource, the first message comprises a random access preamble, and the first radio resource belongs to a first resource set or the first radio resource belongs to a second resource set;
in embodiment 10, the first resource set depends on an indication of the legacy SIB10, and the first signaling is used to determine the second resource set; for any radio resource in the first resource set, whether a candidate for the first radio resource comprises the radio resource depends on at least one of the following:
   whether reception quality of RS resources associated with the radio resource is greater than or not lower than a first threshold, and the first threshold depends on a configuration of the first information;
   whether a candidate for the first radio resource comprises radio resources of the second resource set;
for any radio resource in the second resource set, whether a candidate for the first radio resource comprises the radio resources depends on whether reception quality of RS resources associated with the radio resource is greater than or not lower than a second threshold, and the second threshold depends on a configuration of the second information.

In one embodiment, the probability of any radio resource in the candidate for the first radio resource being selected as the first radio resource is greater than 0.

In one embodiment, the first receiver 1201 receives a first RS resource group, herein, the first resource set and any radio resource in the first resource set are associated with an RS resource of the first RS resource group;

In one embodiment, only when the candidate for the first radio resource does not comprise radio resources of the second resource set, the candidate for the first radio resource comprises radio resources of the first resource set.

In one embodiment, when reception quality of RS resources associated with at least one radio resource in the second resource set is greater than or not lower than the second threshold, the candidate for the first radio resource in the second resource set only comprises radio resources whose reception quality of associated RS resources is greater than or not lower than the second threshold, and the candidate for the first radio resource does not comprise any radio resource whose reception quality of associated RS resources in the first resource set is not lower than or greater than the first threshold.

In one embodiment, the second information is cell-common.

In one embodiment, the second information is UE group-common and the first node is a UE in the UE group.

In one embodiment, the first receiver 1201 receives third information, and the third information and the first signaling are used together to determine the second resource set; herein, the third information is an RRC signaling, and the first signaling is a MAC CE or DCI.

In one embodiment, the first information comprises rsrp-ThresholdSSB, and a name of the second information comprises at least one of rsrp or threshold.

In one embodiment, the candidate for the first radio resource belongs to the first RA resource set, and a value of REAMBLE_TRANSMISSION_COUNTER of an RA process of the first message is used to determine that the first RA resource set comprises the first resource set.

In one embodiment, the first receiver 1201 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises the antenna 452, the receiver 454, the multi-antenna receiving processor 458 and the receiving processor 456 in FIG. 4 of the present application.

In one embodiment, the first receiver 1201 comprises the antenna 452, the receiver 454 and the receiving processor 456 in FIG. 4 of the present application.

In one embodiment, the first transmitter 1202 comprises the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202 comprises the antenna 452, the transmitter 454, the multi-antenna transmitting processor 457 and the transmitting processor 468 in FIG. 4 of the present application.

In one embodiment, the first transmitter 1202 comprises the antenna 452, the transmitter 454 and the transmitting processor 468 in FIG. 4 of the present application.

### Embodiment 11

Embodiment 11 illustrates a structure block diagram of a processor in a second node according to one embodiment of the present application, as shown in FIG. 11. In FIG. 11, a processor 1300 of a second node comprises a second transmitter 1301 and a second receiver 1302.

The second transmitter 1301 transmits first information, second information and a first signaling in step 101, herein, only a former of the first information and the second information belongs to legacy SIB1;
the second receiver 1302 receives a first message on a first radio resource, the first message comprises a random access preamble, the first radio resource belongs to a first resource set or the first radio resource belongs to a second resource set;
in embodiment 11, the first resource set depends on an indication of the legacy SIB11, and the first signaling is used to determine the second resource set; for any radio resource in the first resource set, whether a candidate for the first radio resource comprises the radio resource depends on at least one of the following:
   whether reception quality of RS resources associated with the radio resource is greater than or not lower than a first threshold, and the first threshold depends on a configuration of the first information;
   whether a candidate for the first radio resource comprises radio resources of the second resource set;
for any radio resource in the second resource set, whether a candidate for the first radio resource comprises the radio resources depends on whether reception quality of RS resources associated with the radio resource is greater than or not lower than a second threshold, and the second threshold depends on a configuration of the second information.

In one embodiment, the second receiver detects at least random access preamble on each radio resource in the candidate for a first radio resource.
before receiving a first message, a second node is unaware of the first radio resource selected by the first node, so the above embodiment ensures that the second node does not miss detection.

It should be noted that the behavior of the base station is generally not defined in standards or can be implemented by the base station, so the above embodiments are optional.

In one embodiment, the second transmitter 1302 transmits a first RS resource group, herein, the first resource set and any radio resource in the first resource set are associated with an RS resource of the first RS resource group;

In one embodiment, only when the candidate for the first radio resource does not comprise radio resources of the second resource set, the candidate for the first radio resource comprises radio resources of the first resource set.

In one embodiment, when reception quality of RS resources associated with at least one radio resource in the second resource set is greater than or not lower than the second threshold, the candidate for the first radio resource in the second resource set only comprises radio resources whose reception quality of associated RS resources is greater than or not lower than the second threshold, and the candidate for the first radio resource does not comprise any radio resource whose reception quality of associated RS resources in the first resource set is not lower than or greater than the first threshold.

In one embodiment, the second information is cell-common.

In one embodiment, the second information is UE group-common and the first node is a UE in the UE group.

In one embodiment, all UEs in the UE group support the “base station energy saving” function.

In one embodiment, the second transmitter transmit third information, and the third information and the first signaling are used together to determine the second resource set; herein, the third information is an RRC signaling, and the first signaling is a MAC CE or DCI.

In one embodiment, the first information comprises rsrp-ThresholdSSB, and a name of the second information comprises at least one of rsrp or threshold.

In one embodiment, the candidate for the first radio resource belongs to the first RA resource set, and a value of REAMBLE_TRANSMISSION_COUNTER of an RA process of the first message is used to determine that the first RA resource set comprises the first resource set.

In one embodiment, the second transmitter 1301 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises the antenna 420, the transmitter 418, the multi-antenna transmitting processor 471 and the transmitting processor 416 in FIG. 4 of the present application.

In one embodiment, the second transmitter 1301 comprises the antenna 420, the transmitter 418 and the transmitting processor 416 in FIG. 4 of the present application.

In one embodiment, the second receiver 1302 comprises the antenna 420, the receiver 418, the multi-antenna receiving processor 472, the receiving processor 470, the controller/processor 475 and the memory 476 in FIG. 4 of the present application.

In one embodiment, the second receiver 1302 comprises the antenna 420, the receiver 418, the multi-antenna receiving processor 472 and the receiving processor 470 in FIG. 4 of the present application.

In one embodiment, the second receiver 1302 comprises the antenna 420, the receiver 418 and the receiving processor 470 in FIG. 4 of the present application.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving first information, second information and a first signaling, only a former of the first information and second information belonging to legacy SIB1; and
a first transmitter, transmitting a first message on a first radio resource, the first message comprising a random access preamble, the first radio resource belonging to a first resource set or the first radio resource belonging to a second resource set;
wherein the first resource set depends on an indication of the legacy SIB1, and the first signaling is used to determine the second resource set; for any radio resource in the first resource set, whether a candidate for the first radio resource comprises the radio resource depends on at least one of the following:
whether reception quality of RS resources associated with the radio resource is greater than or not lower than a first threshold, and the first threshold depends on a configuration of the first information;
whether a candidate for the first radio resource comprises radio resources of the second resource set;
for any radio resource in the second resource set, whether a candidate for the first radio resource comprises the radio resources depends on whether reception quality of RS resources associated with the radio resource is greater than or not lower than a second threshold, and the second threshold depends on a configuration of the second information.

2. The first node according to claim 1, comprising:
the first receiver, receiving a first RS resource group;
wherein the first resource set and any radio resource in the first resource set are associated with an RS resource of the first RS resource group.

3. The first node according to claim 1, wherein only when the candidate for the first radio resource does not comprise radio resources of the second resource set, the candidate for the first radio resource comprises radio resources of the first resource set.

4. The first node according to claim 1, wherein when reception quality of RS resources associated with at least one radio resource in the second resource set is greater than or not lower than the second threshold, the candidate for the first radio resource in the second resource set only comprises radio resources whose reception quality of associated RS resources is greater than or not lower than the second threshold, and the candidate for the first radio resource does not comprise any radio resource whose reception quality of associated RS resources in the first resource set is not lower than or greater than the first threshold.

5. The first node according to claim 1, wherein the second information is cell-common, or, the second information is UE group-common and the first node is a UE in the UE group.

6. The first node according to claim 1, comprising:
the first receiver, receiving third information, the third information and the first signaling being used together to determine the second resource set;
wherein the third information is an RRC signaling, and the first signaling is a MAC CE or DCI.

7. The first node according to claim 1, wherein the first information comprises rsrp-ThresholdSSB, and a name of the second information comprises at least one of rsrp or threshold.

8. The first node according to claim 1, wherein the candidate for the first radio resource belongs to the first RA resource set, and a value of REAMBLE_TRANSMISSION CO UNTER of an RA process of the first message is used to determine that the first RA resource set comprises the first resource set.

9. A second node for wireless communications, comprising:
a second transmitter, transmitting first information, second information and a first signaling, only a former of the first information and second information belonging to legacy SIB1; and
a second receiver, receiving a first message on a first radio resource, the first message comprising a random access preamble, the first radio resource belonging to a first resource set or the first radio resource belonging to a second resource set;
wherein the first resource set depends on an indication of the legacy SIB1, and the first signaling is used to determine the second resource set; for any radio resource in the first resource set, whether a candidate for the first radio resource comprises the radio resource depends on at least one of the following:
whether reception quality of RS resources associated with the radio resource is greater than or not lower than a first threshold, and the first threshold depends on a configuration of the first information;
whether a candidate for the first radio resource comprises radio resources of the second resource set;
for any radio resource in the second resource set, whether a candidate for the first radio resource comprises the radio resources depends on whether reception quality of RS resources associated with the radio resource is greater than or not lower than a second threshold, and the second threshold depends on a configuration of the second information.

10. The second node according to claim 9, comprising:
the second receiver, detecting at least random access preamble on each radio resource in the candidate for a first radio resource.

11. The second node according to claim 9, comprising:
the second transmitter, transmitting a first RS resource group;
wherein the first resource set and any radio resource in the first resource set are associated with an RS resource of the first RS resource group.

12. The second node according to claim 9, wherein only when the candidate for the first radio resource does not comprise radio resources of the second resource set, the candidate for the first radio resource comprises radio resources of the first resource set.

13. The second node according to claim 9, wherein when reception quality of RS resources associated with at least one radio resource in the second resource set is greater than or not lower than the second threshold, the candidate for the first radio resource in the second resource set only comprises radio resources whose reception quality of associated RS resources is greater than or not lower than the second threshold, and the candidate for the first radio resource does not comprise any radio resource whose reception quality of associated RS resources in the first resource set is not lower than or greater than the first threshold.

14. The second node according to claim 9, wherein the second information is cell-common, or the second information is UE group-common and the first node is a UE in the UE group.

15. The second node according to claim 9, comprising:
the second transmitter, transmitting third information, the third information and the first signaling being used together to determine the second resource set;
wherein the third information is an RRC signaling, and the first signaling is a MAC CE or DCI.

16. The second node according to claim 9, wherein the first information comprises rsrp-ThresholdSSB, and a name of the second information comprises at least one of rsrp or threshold.

17. The second node according to claim 9, wherein the candidate for the first radio resource belongs to the first RA resource set, and avalue of REAMBLE_TRANSMISSION_COUNTER of an RA process of the first message is used to determine that the first RA resource set comprises the first resource set.

18. A method in a first node for wireless communications, comprising:
receiving first information, second information and a first signaling, only a former of the first information and second information belonging to legacy SIB1; and
transmitting a first message on a first radio resource, the first message comprising a random access preamble, the first radio resource belonging to a first resource set or the first radio resource belonging to a second resource set;
wherein the first resource set depends on an indication of the legacy SIB1, and the first signaling is used to determine the second resource set; for any radio resource in the first resource set, whether a candidate for the first radio resource comprises the radio resource depends on at least one of the following:
whether reception quality of RS resources associated with the radio resource is greater than or not lower than a first threshold, and the first threshold depends on a configuration of the first information;
whether a candidate for the first radio resource comprises radio resources of the second resource set;
for any radio resource in the second resource set, whether a candidate for the first radio resource comprises the radio resources depends on whether reception quality of RS resources associated with the radio resource is greater than or not lower than a second threshold, and the second threshold depends on a configuration of the second information.

19. The method in a first node according to claim 18, comprising:
receiving a first RS resource group;
wherein the first resource set and any radio resource in the first resource set are associated with an RS resource of the first RS resource group.

20. The method in a first node according to claim 18, wherein only when the candidate for the first radio resource does not comprise radio resources of the second resource set, the candidate for the first radio resource comprises radio resources of the first resource set.
